(19) United States
(12) Patent Application Publication
(10) Pub. No.: US 2009/0268080 A1
(43) Pub. Date: Oct. 29, 2009

(54) Bracketing apparatus and method for use in digital image processor

(75) Inventors: Won-Seok Song, Changwon-city (KR); Sung-Kyu Jang, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/380,226

(22) Filed: Feb. 25, 2009

(30) Foreign Application Priority Data
Apr. 25, 2008 (KR) 10-2008-0038954

(51) Int. Cl. H04N 5/232

(52) U.S. Cl. 348/349; 348/E05.042

(57) ABSTRACT

Provided are an apparatus for and method of processing a digital image, specifically, a bracketing apparatus and method for use in a digital image processor, which can reduce a photographing time by calculating focuses for all detected faces by moving a focus motor only once after face detection, and then performing bracketing by compensating the focuses by an interval of the focus motor applied while calculating the focuses of each face. The bracketing apparatus includes a digital signal processor, which detects one or more faces from a live-view image, detects focus values for all detected faces by moving a focus motor only once, and then performs bracketing by compensating a focus by an interval of the focus motor applied while detecting the focus values of each face.

### CROSS-REFERENCE TO RELATED PATENT APPLICATION

This application claims the benefit of Korean Patent Application No. 10-2008-0038954, filed on Apr. 25, 2008, in the Korean Intellectual Property Office, the disclosure of which is incorporated herein in its entirety by reference.

### BACKGROUND OF THE INVENTION

1. Field of the Invention

The present invention relates to an apparatus for and method of processing a digital image, and more particularly, to a bracketing apparatus and method for use in a digital image processor, which can reduce a photographing time by detecting focuses of all detected faces by moving a focus motor only once after face detection, and then, after once moving the focus motor, performing bracketing by compensating the focuses by an interval of the focus motor applied while collectively detecting the focus of each face.

2. Description of the Related Art

When a person is photographed using a conventional photographing apparatus, the face of the person is detected and auto exposure (AE) and auto focus (AF) are performed based on the area of the detected face. Such an operating mode is called a face detection mode. A conventional digital image processor does not have a separate face detection mode, and face focusing is automatically performed in a live-view image.

A conventional method of automatically adjusting a focus when a face is detected without performing AF can be performed because, when a window size of the detected face is known, a distance between a subject and a digital image processor can be predicted. In order to automatically perform AF by using such method, a look up table for determining the distance between the subject and the digital image processor by using the size of the detected face is required. However, since in this method, the distance between the subject and the digital image processor is determined only by using information about the window size, errors may be generated if a method of accounting for different face sizes of an adult and a child is not used. However, the method is advantageous since the focus is adjusted automatically without performing AF. Also, when several people are detected during face detection, an image is photographed after AF is performed with respect to all faces. Accordingly, a user can take an image by adjusting focusing with respect to the face of a desired person.

AF should be performed with respect to each face when several faces are detected in the image. However, it takes long time to perform AF on all detected faces. When the distance between the subject and the digital image processor is determined only according to the window size, the image is photographed without performing AF on each face, and thus no time is consumed by AF. However, in this case, the digital image processor cannot accurately account for faces of different sizes, and thus the focuses on the respective faces are not accurate.

### SUMMARY

The present invention provides a bracketing apparatus and method for use in a digital image processor, which can reduce a photographing time by detecting focuses of all detected faces by moving a focus motor only once after face detection, and performing bracketing by compensating the focuses by an interval of the focus motor applied while detecting the focuses of the respective faces.

According to an aspect of the present invention, there is provided a bracketing apparatus for use in a digital image processor, the bracketing apparatus comprising a digital signal processor, which detects one or more faces from a live-view image, detects focus values of all detected faces by moving a focus motor only once, and then, after once moving the focus motor, performs bracketing by compensating for a focus by an interval of the focus motor applied while detecting each focus value of each face.

The digital signal processor may comprise: a face detector, which detects the faces from the live-view image; a focus value detector, which detects the focus values for all of the detected faces by moving the focus motor only once; and a controller, which performs bracketing by moving the focus motor from the face nearest to the point where the focus motor stopped moving to the point corresponding to a focus peak value of each face.

The digital signal processor may further comprise an auto focus (AF) window setting unit, which assigns an AF window to each detected face.

The AF window may be assigned according to the size and location of the detected face.

The focus value detector may perform full search by moving the focus motor within a motion range set according to a focus mode and a zoom grade.

The controller may perform bracketing by moving the focus motor from an AF window nearest to the point where the focus motor stopped moving to a point corresponding to a focus peak value of each AF window.

According to another aspect of the present invention, there is provided a bracketing apparatus for use in a digital image processor, the bracketing apparatus comprising: a focus motor, which controls a motion of a focus lens; and a digital signal processor, which detects one or more faces from a live-view image, detects focus values of all detected faces by moving the focus motor at least once, and then performs bracketing by compensating a focus by an interval of the focus motor applied while detecting focus values of each face.

The focus motor may perform a full search within a motion range set according to a focus mode and a zoom grade, and sequentially move from a face nearest to or farthest from a point where the focus motor stopped moving.

The digital signal processor may comprise: a face detector, which detects the faces from the live-view image; an AF window setting unit, which assigns an AF window to each detected face; a focus value detector, which detects focus values for all of the assigned AF windows by performing a full search via the focus motor; and a controller, which performs bracketing by moving the focus motor from an AF window nearest to a point where the focus motor stopped moving to a point corresponding to a focus peak value of each AF window.

The AF window may be assigned according to the size and location of the detected face.

According to another aspect of the present invention, there is provided a bracketing method for use in a digital image processor, the bracketing method comprising: (a) detecting one or more faces from a live-view image; (b) detecting focus values for all of the detected faces by moving a focus motor only once; and (c) performing bracketing by moving the focus motor from a face nearest to or farthest from a point where the focus motor stopped moving to a point corresponding to a focus peak value of each face.

(b) may comprise: (b-1) assigning an AF window to each detected face; (b-2) full searching via the focus motor; and (b-3) detecting focus peak values for all AF windows.

The AF window may be assigned according to the size and location of the detected face.

The focus motor may perform a full search within a motion range set according to a focus mode and a zoom grade.

(c) may comprise: (c-1) calculating an interval between the focus peak values of each face from the face farthest from the point where the focus motor stopped moving; and (c-2) performing the bracketing by moving the focus motor by the interval by pressing a shutter only once.

(c) may comprise: (c-1) calculating an interval between the focus peak values of each face from the face nearest to the point where the focus motor stooped moving; and (c-2) performing the bracketing by moving the focus motor by the interval by pressing a shutter only once.

### BRIEF DESCRIPTION OF THE DRAWINGS

The above and other features and advantages of the present invention will become more apparent by describing in detail exemplary embodiments thereof with reference to the attached drawings in which:

FIG. 1 is a lateral perspective view of a digital image processor;

FIG. 2 is a rear view of the digital image processor of FIG. 1;

FIG. 3 is a block diagram illustrating a bracketing apparatus for use in a digital image processor according to an embodiment of the present invention;

FIG. 4A is a diagram for describing an auto focus (AF) window of a live-view image displayed on a display unit of FIG. 3;

FIG. 4B is a diagram for describing an AF window of an image processed by a digital signal processor of FIG. 3;

FIG. 5A is a graph for describing conventional AF performance;

FIG. 5B is a graph illustrating a motion range of a focus motor;

FIG. 5C is a graph for describing AF performance in a digital image processor according to various embodiments of the present invention;

FIG. 5D is a graph showing AF waveforms with respect to all faces detected by moving a focus motor at least once in a digital image processor according to various embodiments of the present invention; and

FIG. 6 is a flowchart of a method of bracketing in a digital image processor according to an embodiment of the present invention.

### DETAILED DESCRIPTION OF THE PREFERRED EMBODIMENTS

Hereinafter, various embodiments of the present invention will be described more fully with reference to the accompanying drawings, in which exemplary embodiments of the invention are shown.

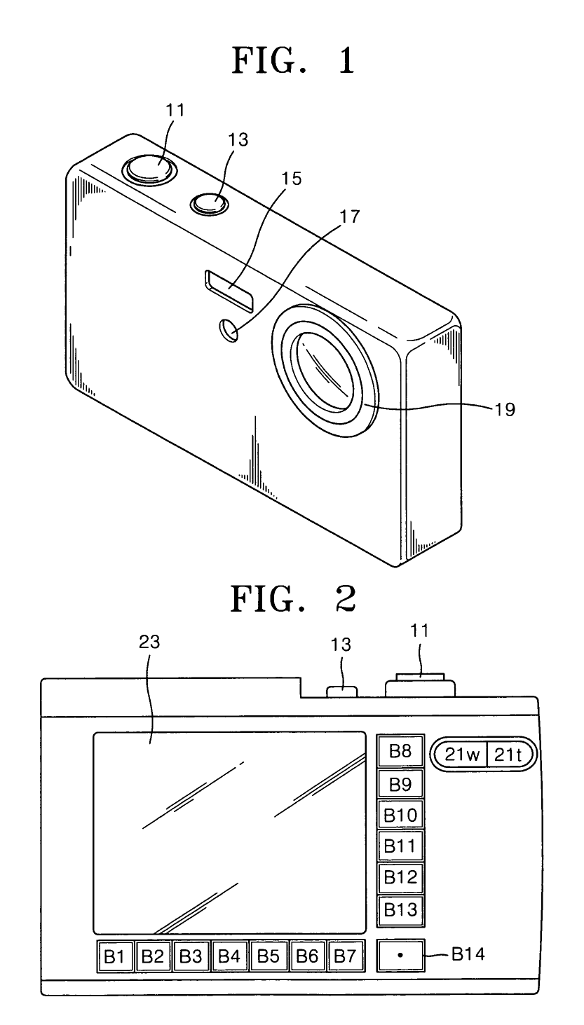

FIG. 1 is a lateral perspective view of a digital image processor.

Referring to FIG. 1, a shutter-release button 11 opens or closes a shutter (not shown) so as to expose a charge-coupled device (CCD) to light for a predetermined time, and records an image in the CCD by appropriately exposing a subject in association with an iris (not shown).

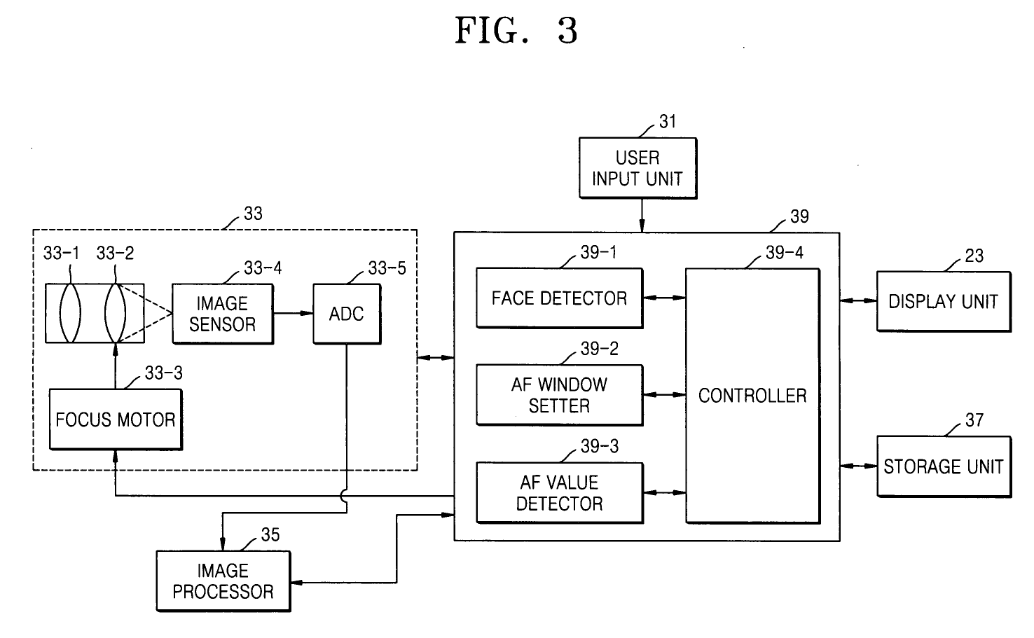

The shutter-release button 11 generates first and second image photographing signals in response to a user's push. When the shutter-release button 11 is half-pressed, the first image photographing signal is generated and the digital image processor adjusts a focus and the amount of light. When the focus is right, a green light is lighted on a display unit 23 of FIG. 2. After the focus and the amount of light are adjusted in response to the first image photographing signal, the image is photographed in response to the second image photographing signal generated when the shutter-release button 11 is fully-pressed.

Power is supplied to the to the digital image processor when a power supply button 13 is pressed.

When the image is photographed in a dark place, a flash 15 instantly generates light. Examples of a flash mode include an auto flash mode, an enforced flash mode, no flash mode, a red-eye reduction mode, and a slow synchronization mode.

When the amount of light is not sufficient, an auxiliary light 17 supplies light to the subject to be photographed so that the digital image processor can automatically, quickly, and accurately adjust the focus.

A lens 19 processes optically processes light from the subject.

FIG. 2 is a rear view of the digital image processor of FIG. 1. The digital image processor further includes a wide angle zoom button 21w, a telephoto zoom button 21t, a display unit 23, and input buttons B1 through B14 (hereinafter, referred to as buttons B1 through B14). The buttons B1 through B14 can be a touch sensor or a contact switch.

A view angle is enlarged or reduced according to the operation of the wide angle zoom button 21w or the telephoto zoom button 21t, and specifically, the wide angle zoom button 21w and the telephoto zoom button 21t are used in order to change the size of a selected exposure area. When the wide angle zoom button 21w is operated, the size of the selected exposure area is reduced, and when the telephoto zoom button 21t is operated the size of the selected exposure area is increased.

The buttons B1 through B14 are arranged vertically and horizontally on the display unit 23.

When the buttons B1 through B14 are touch sensors, a predetermined value (for example, color or brightness) from among main menu items can be selected, or a sub-menu icon included in main menu icons can be activated by moving a finger in top/down/left/right direction on the horizontal input buttons B1 through B7 or the vertical input buttons B8 through B14.

If the buttons B1 through B14 are contact switches, the main menu icon and a sub-menu icon can be directly selected so as to execute a corresponding function. A touch sensor requires weaker pressing than a contact switch, but the input of the touch type switch requires stronger touch than an input of the touch sensor.

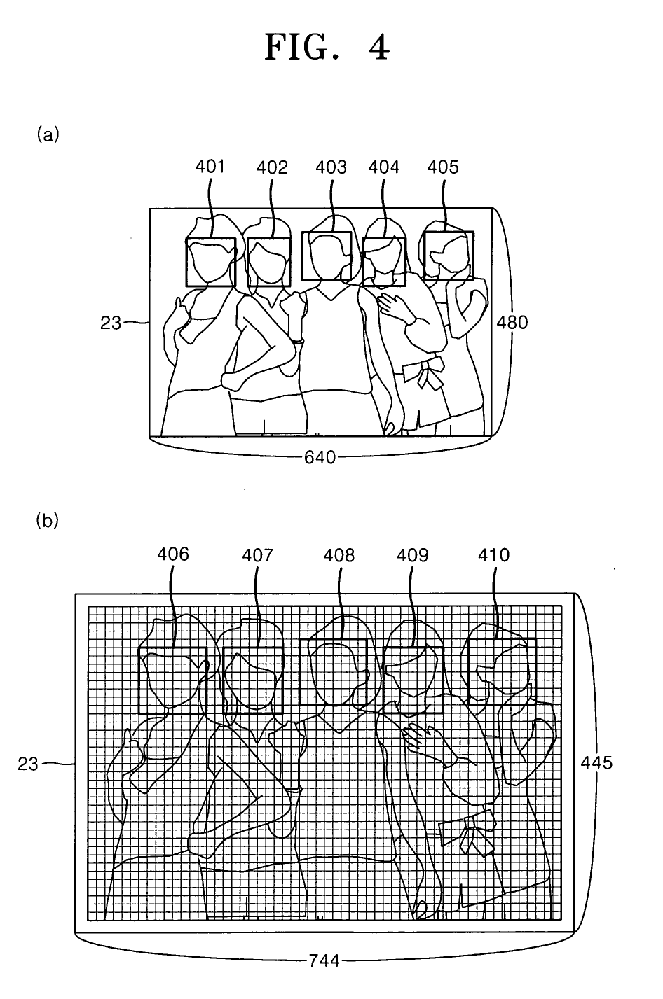

FIG. 3 is a block diagram illustrating a bracketing apparatus for use in a digital image processor according to an embodiment of the present invention. The bracketing apparatus includes a display unit 23, a user input unit 31, a pickup unit 33, an image processor 35, a storage unit 37, and a digital signal processor 39.

Referring back to FIG. 2, the user input unit 31 includes the shutter release button 11, which opens or closes the shutter so as to expose a CCD to light for a predetermined time, the power supply button 13 for supplying power, the wide angle zoom button 21w and the telephoto zoom button 21t, which respectively widens and narrows the view angle, and the buttons B1 through B14 arranged vertically and horizontally on the display unit 23 for inputting a character or selecting and executing a function.

The pickup unit 33 includes a zoom lens 33-1, a focus lens 33-2, a focus motor 33-3, an image sensor 33-4, an analog digital converter (ADC) 33-5, a shutter (not shown), and an iris (not shown).

The shutter and the iris are elements that adjust the amount of light. The zoom lens 33-1 and the focus lens 33-2 optically processes light from a subject. The iris adjusts the amount of incident light according to how much the iris is opened or closed. The opening and closing of the iris is controlled by the digital signal processor 39.

The optical axes of the zoom lens 33-1 and the focus lens 33-2 are arranged along a vertical line extending from the center of the light-receiving surface of the image sensor 33-4. The focus lens 33-2 is movable along the optical axis, and a focus of an image on the light-receiving surface of the image sensor 33-4 changes according to the location of the focus lens 33-2. The location of the focus lens 33-2 is controlled by the digital signal processor 39 via the focus motor 33-3.

The image sensor 33-4 accumulates the amount of light received via the zoom lens 33-1 and the focus lens 33-2, and outputs an image formed on the zoom lens 33-1 and the focus lens 33-2 according to the accumulated amount of light in response to a vertical synchronization signal. The digital image processor obtains an image via the image sensor 33-4, which converts light reflected from a subject to an electric signal. A color filter is required to obtain a color image by using the image sensor 33-4, and in the current embodiment, a color filter array (CFA) is used. The CFA passes only light for forming one color per one pixel, has a systematic structure, and has various external shapes depending on the structure. The ADC 33-5 converts an analog image signal outputted from the image sensor 33-4 to a digital image signal.

The image processor 35 signal processes digital converted raw data to a displayable format. The image processor 35 removes a black level due to a dark current generated by the CCD and the CFA that are sensitive to temperature change. The image processor 35 performs gamma compensation wherein information is encoded according to the non-linearity of human sight. The image processor 35 performs CFA interpolation wherein a Bayer pattern realized by an RGRG line and a GBGB line of predetermined gamma compensated data is interpolated into an RGB line. The image processor 35 converts the interpolated RGB signal to a YUV signal, performs edge compensation, wherein an image is compensated for by filtering a Y signal via a high band filter, and color correction, wherein color values of U and V signals are corrected by using a standard color coordinate, and removes noise thereof. The image processor 35 generates a JPEG file by compressing and signal processing the Y, U, and V signals from which the noise was removed. The generated JPEG file is displayed on the display unit 23, and stored in the storage unit 37. The operations of the image processor 35 are controlled by the digital signal processor 39.

The digital signal processor 39 detects a face in a live-view image, detects focus values of all detected faces by moving the focus motor 33-3 only once, and then, after moving the focus motor only once, performs bracketing by compensating for a focus by an interval of the focus motor 33-3 applied while detecting focus values of each face.

The digital signal processor 39 includes a face detector 39-1, an AF window setting unit 39-2, an AF value detector 39-3, and a controller 39-4.

Under the control of the controller 39-4, the face detector 39-1 detects face information about at least one face from a live-view image displayed on the display unit 23. The face information detected by the face detector 39-1 may include a face detection window size, a face detection window starting location, an inclination degree of the detected face, and the number of faces. Various methods and system generally known in the art may be used for detecting the face information by the face detector 39-1.

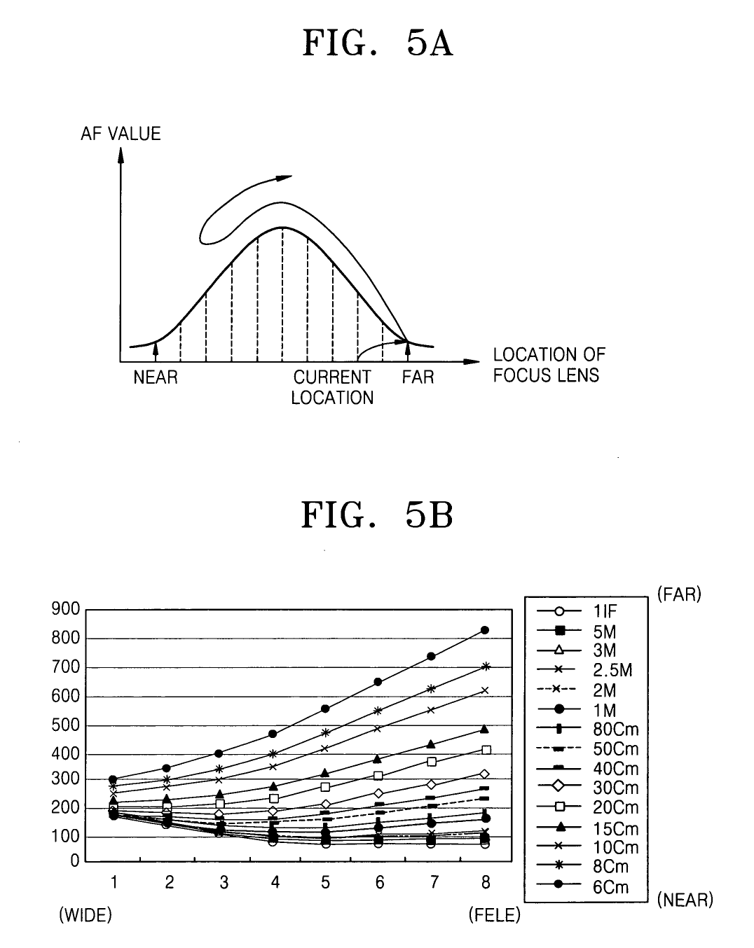

FIG. 4A is a diagram for describing an AF window in the live-view image displayed on the display unit 23. Referring to FIG. 4A, faces detected in the live-view image are illustrated. The face detector 39-1 detects 5 faces from the live-view image, and displays face detection windows 401, 402, 403, 404, and 405.

The AF window setting unit 39-2 assigns an AF window to each face detected by the face detector 39-1. In order to perform auto focus, an AF value should be extracted from the live-view image, and this should be performed via AF filter setting and AF window setting of the controller 39-4. In the AF window setting of the controller 39-4, a fixed AF window divided into a single window and a multi window in a general mode is used. However, in order to perform the auto focus according to face detection, an AF window corresponding to a face location should be set up. Accordingly, the face detection windows 401, 402, 403, 404, and 405 illustrated in FIG. 4A are AF windows.

The AF value detector 39-3 detects the focus values of all detected faces by moving the focus motor 33-3 only once.

The live-view image illustrated in FIG. 4A is displayed after being reduced to be suitable to the size of the display unit 23, for example, 640×480. In order to detect the focus values, the controller 39-4 should re-set an AF window from the live-view image displayed on the display unit 23, because the size of the AF window should be adjusted since the digital signal processor 39 sets the AF window by using an input image of FIG. 4A. The size of the input image of FIG. 4A is, for example, 640×480, and the controller 39-3 sets the AF window by converting the size of the live-view image displayed on the display unit 23 to, for example, 744×445. FIG. 4B is a diagram illustrating an example of enlarging the live-view image of FIG. 4A, and illustrates AF windows 406, 407, 408, 409, and 410 of the enlarged live-view image. The AF windows 401, 402, 403, 404, and 405 of FIG. 4A respectively correspond to the AF windows 406, 407, 408, 409, and 410 of FIG. 4B.

The AF value detector 39-3 calculates AF values by adding edge information obtained by performing AF filtering on the AF windows 406, 407, 408, 409, and 410 of FIG. 4B.

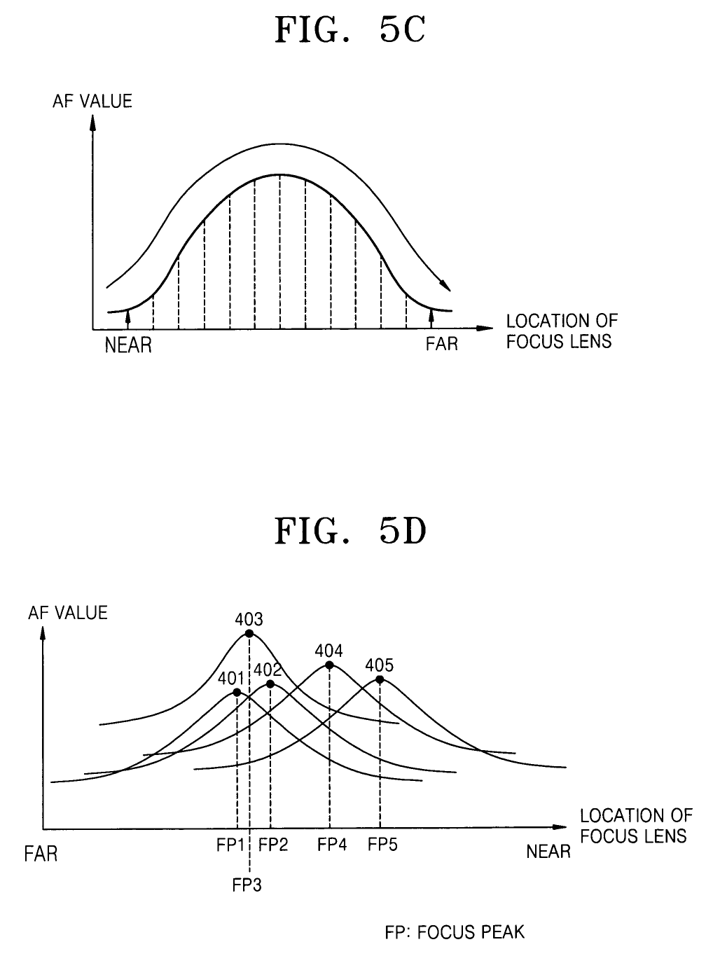

FIG. 5A is a graph for describing the AF performance for outputting AF value. Conventionally, an AF value is extracted by moving the focus lens 33-2 by a basic step a current location, and then the maximum AF value is obtained by inversely moving and fixing the focus lens 33-2 by a focus peak value. An arrow illustrated in FIG. 5A denotes a searching operation performed by the focus motor 33-3 so as to move the focus lens 33-3 to a position with the best focus, and this is called a climb and reverse (CNR) method. In this case, however, a lot of time is consumed since AF should be performed on each detected face. In other words, a lot of time is consumed because AF is performed on each of the 5 AF windows 406, 407, 408, 409, and 410 of FIG. 4B.

For example, in the current embodiment of the present invention, after 5 faces are detected, the first image photographing signal is generated so as to perform AF. Then, instead of using the CNR method, the focus motor 33-3 moves within a search range allowable in a set up AF mode. Examples of the AF mode may include a normal mode, a macro mode, an auto macro mode, and a super macro mode. The search range in which the focus motor 33-3 may move is determined according to each AF mode.

FIG. 5B is a waveform illustrating the search range of the focus motor 33-3. The X axis indicates a zoom grade and the Y axis indicates the amount of focus step. For example, in order to adjust the focus from 6 cm to infinite in a zoom first grade, the focus motor 33-3 should move approximately form 150 to 300 steps.

In the current embodiment, the focus motor 33-3 is moved via a full search instead of using the CNR method, within a range movable according to each AF mode and each zoom grade. FIG. 5C is a graph for describing the AF performance in a digital image processor according to the present invention. In other words, an AF waveform for all AF windows 406, 407, 408, 409, and 410 can be obtained by performing one full search using the focus motor 33-3. FIG. 5D shows 5 AF waveforms of all faces detected by in a full searching using the focus motor 33-3, according to an embodiment of the present invention.

The controller 39-4 calculates an interval by moving the focus motor 33-3 from an AF window nearest to a point where the focus motor 33-3 stopped moving to a point corresponding to a focus peak value of each AF window.

Referring to FIG. 5D, the controller 39-3 sequentially calculates an interval (Interval_5) of the focus motor 33-3 of the AF window 405 by Near-FP5, an interval (Interval_4) of the AF window 404 by FP5-FP4, an interval (Interval_3) of the AF window 402 by FP4-FP2, an interval (Interval_2) of the AF window 403 by FP2-FP3, and an interval (Interval_4) of the AF window 401 by FP3-FP1.

After calculating the intervals, the controller 39-4 performs the bracketing when the second image photographing signal is generated. The bracketing is performed around the AF window 405 that is nearest from a point where the AF performance is completed. Then, the focus motor 33-3 is moved by Interval_4, and the bracketing is performed around the AF window 404. Then focus motor 33-3 is moved by Interval_3, and the bracketing is performed around the AF window 402. Next, the focus motor 33-3 is moved by Interval_2, and the bracketing is performed around the AF window 403. Lastly, the focus motor 33-3 is moved by Interval_1, and the bracketing is performed around the AF window 401.

The bracketing starts from the nearest AF window 405 when the searching direction of the focus motor 33-3 is Far→Near. If the searching direction of the focus motor 33-3 is Near→Far, the bracketing is performed after calculating an interval from the farthest AF window 401. Accordingly, AF is not required to be performed on each face, and thus the photographing time can be reduced by reducing the motion of the focus motor 33-3.

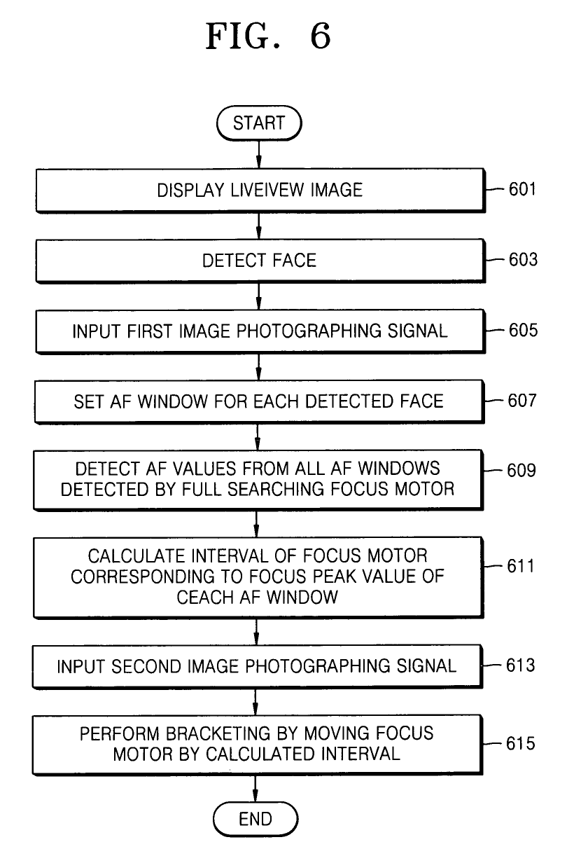

FIG. 6 is a flowchart of a bracketing method for use in a digital image processor according to an embodiment of the present invention. The method according to the current embodiment may be performed by the digital signal processor 39.

When a live-view image is displayed on the display unit 23 in operation 601, the digital signal processor 39 detects a face from the live-view image in operation 603.

Face information about the face detected by the digital signal processor 39 may include a face detection window size, a face detection window starting location, inclination degree of the detected face, and the number of faces. Referring back to FIG. 4A, the faces are detected from the live-view image displayed on the display unit 23. The digital signal processor 39 detects 5 faces from the live-view image, and displays the face detection windows 401, 402, 403, 404, and 405.

Then, when a first image photographing signal is generated in operation 605, the digital signal processor 39 assigns an AF window to each detected face in operation 607.

In order to perform auto focus, an AF value should be extracted from the live-view image. This is performed via AF filter setting and AF window setting of the digital signal processor 39. In the AF window setting of the digital signal processor 39, a fixed AF window may be divided into a single window and a multi window in a general mode is used. However, in order to perform the auto focus according to face detection, an AF window corresponding to a face location should be set up. Accordingly, the face detection windows 401, 402, 403, 404, and 405 illustrated in FIG. 4A are AF windows.

After the AF windows are assigned, the digital signal processor 39 detects AF values from all AF windows detected by performing full search by moving the focus motor 33-3 within a search range corresponding to an AF mode in operation 609.

The live-view image illustrated in FIG. 4A is displayed after being reduced to the size of the display unit 23, for example 640×480. In order to detect an AF value, the digital signal processor 39 should re-set an AF window from the live-view image displayed on the display unit 23. Accordingly, the digital signal processor 39 converts the size of the live-view image to, for example, 744×445. FIG. 4B is a diagram illustrating an example of enlarging the live-view image of FIG. 4A, and illustrates AF windows 406, 407, 408, 409, and 410 of the enlarged live-view image. Here, the AF windows 401, 402, 403, 404, and 405 of FIG. 4A respectively correspond to the AF windows 406, 407, 408, 409, and 410 of FIG. 4B. The digital signal processor 39 calculates AF values by adding edge information obtained by performing AF filtering on the AF windows 406, 407, 408, 409, and 410 of FIG. 4B.

When AF is performed by using the CNR method illustrated in FIG. 5A, much time is consumed since AF should be performed on each detected face. In other words, much time is consumed since AF should be performed on each of the 5 detected AF windows 406, 407, 408, 409, and 410 in FIG. 4B. However in the current embodiment, after the 5 faces are detected, the first image photographing signal is generated so as to perform AF. Then, instead of using the CNR method, the focus motor 33-3 moves within a search range allowable in a set up AF mode. FIG. 5C is a graph for describing the AF performance in a digital image processor according to the present invention. In other words, an AF waveform for all AF windows 406, 407, 408, 409, and 410 can be obtained by performing one full search via the focus motor 33-3. FIG. 5D shows 5 AF waveforms obtained by full searching via the focus motor 33-3.

When the AF values of the AF windows detected by performing full search via the focus motor 33-3 are detected, the digital signal processor 39 calculates an interval by moving the focus motor 33-3 from an AF window nearest to a point where the focus motor 33-3 stopped moving to a point corresponding to a focus peak value of each AF window in operation 611.

Referring to FIG. 5D, the digital signal processor 39 sequentially calculates an interval (Interval_5) of the focus motor 33-3 of the AF window 405 by Near-FP5, an interval (Interval_4) of the AF window 404 by FP5-FP4, an interval (Interval_3) of the AF window 402 by FP4-FP2, an interval (Interval_2) of the AF window 403 by FP2-FP3, and an interval (Interval_4) of the AF window 401 by FP3-FP1. The bracketing starts from the nearest AF window 405 when the searching direction of the focus motor 33-3 is Far→Near. If the searching direction of the focus motor 33-3 is Near→Far, the bracketing is performed after calculating an interval from the farthest AF window 401.

Then, when the second image photographing signal is generated in operation 613, the digital signal processor 39 performs bracketing by moving the focus lens 33-2 by the calculated intervals in operation 615.

First, the bracketing is performed around the AF window 405 that is nearest from a point where the AF performance is completed. Then, the focus motor 33-3 is moved by Interval_4, and the bracketing is performed around the AF window 404. Then focus motor 33-3 is moved by Interval_3, and the bracketing is performed around the AF window 402. Next, the focus motor 33-3 is moved by Interval_2, and the bracketing is performed around the AF window 403. Lastly, the focus motor 33-3 is moved by Interval_1, and the bracketing is performed around the AF window 401.

By using the bracketing method according to the current embodiment of the present invention, it is not required to perform AF on each face. Accordingly, the photographing time can be reduced by reducing the motion of the focus motor 33-3.

According to the present invention, focus on each face detected by moving a focus motor only once after face detection is detected, and bracketing is performed by compensating for the focus by an interval of the focus motor applied while detecting the focuses of each face. Accordingly, the photographing time can be reduced by reducing the motion of the focus motor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bracketing apparatus for use in a digital image processor, comprising:
a digital signal processor; wherein the digital signal processor:
detects one or more faces from a live-view image;
detects focus values of all detected faces by moving a focus motor only once; and
performs bracketing by compensating for a focus by an interval of the focus motor applied while detecting a respective focus value for each of the one or more faces.

2. The bracketing apparatus of claim 1, wherein the digital signal processor comprises:
a face detector for detecting one or more faces from the live-view image;
a focus value detector for detecting focus values for all of the detected faces by moving the focus motor only once; and
a controller for performing bracketing by moving the focus motor from the face nearest to the point where the focus motor stopped moving to the point corresponding to a focus peak value of each face.

3. The bracketing apparatus of claim 2, wherein the digital signal processor further comprises an auto focus (AF) window setting unit for assigning at least one AF window to each detected face.

4. The bracketing apparatus of claim 3, wherein the AF window is assigned according to the size and location of the detected face.

5. The bracketing apparatus of claim 3, wherein the focus value detector performs at least one full search by moving the focus motor within a motion range set according to a focus mode and a zoom grade.

6. The bracketing apparatus of claim 5, wherein the controller performs bracketing by moving the focus motor from an AF window nearest to the point where the focus motor stopped moving to a point corresponding to a focus peak value of each AF window.

7. A bracketing apparatus for use in a digital image processor, the bracketing apparatus comprising:
a focus motor for controlling motion of a focus lens; and
a digital signal processor for detecting one or more faces from a live-view image, detecting focus values of the detected faces by moving the focus motor at least once, and performing bracketing by compensating a focus by an interval of the focus motor applied while detecting focus values of each face.

8. The bracketing apparatus of claim 7, wherein the focus motor performs at least one full search within a motion range set according to a focus mode and a zoom grade, and sequentially moves from a face nearest to or farthest from a point where the focus motor stopped moving.

9. The bracketing apparatus of claim 8, wherein the digital signal processor comprises:
a face detector for detecting the faces from the live-view image;
an AF window setting unit for assigning at least one AF window to each detected face;
a focus value detector for detecting focus values for the assigned AF windows by performing at least one full search via the focus motor; and
a controller for performing bracketing by moving the focus motor from an AF window nearest to a point where the focus motor stopped moving to a point corresponding to a focus peak value of each AF window.

10. The bracketing apparatus of claim 9, wherein the AF window is assigned according to the size and location of the detected face.

11. A bracketing method for use in a digital image processor, the bracketing method comprising:
(a) detecting one or more faces from a live-view image;
(b) detecting focus values for the detected faces by moving a focus motor only once; and
(c) performing bracketing by moving the focus motor from a face nearest to or farthest from a point where the focus motor stopped moving to a point corresponding to a focus peak value of each face.

12. The bracketing method of claim 11, wherein (b) comprises:
(b-1) assigning an AF window to each detected face;
(b-2) performing at least one full search via the focus motor; and
(b-3) detecting focus peak values for all AF windows.

13. The bracketing method of claim 12, wherein the AF window is assigned according to the size and location of the detected face.

14. The bracketing method of claim 12, wherein the focus motor performs at least one full search within a motion range set according to a focus mode and a zoom grade.

15. The bracketing method of claim 12, wherein (c) comprises:
(c-1) calculating an interval between the focus peak values of each face from the face farthest from the point where the focus motor stopped moving; and
(c-2) performing the bracketing by moving the focus motor by the interval by pressing a shutter only once.

16. The bracketing method of claim 12, wherein (c) comprises:
(c-1) calculating an interval between the focus peak values of each face from the face nearest to the point where the focus motor stooped moving; and
(c-2) performing the bracketing by moving the focus motor by the interval by pressing a shutter only once.
